(19) United States
(12) Patent Application Publication
(10) Pub. No.: US 2021/0133676 A1
(43) Pub. Date: May 6, 2021

(54) Shipping Dock Detention Data

(71) Applicant: J.J. Keller & Associates, Inc., Neenah, WI (US)

(72) Inventors: Steven Duane Myers, Lee's Summit, MO (US); Joel Hererra, Appleton, WI (US); Amy Daley, Appleton, WI (US)

(21) Appl. No.: 16/669,988

(22) Filed: Oct. 31, 2019

(51) Int. Cl. G06Q 10/08; G06Q 10/06; G01S 19/51

(52) U.S. Cl. CPC G06Q 10/08355; G06Q 10/0633; H04M 1/725; G01S 19/51; G06Q 10/06393

(57) ABSTRACT

The present invention relates generally to calculating, accumulating and predicting shipping dock detention data for vehicles at shipping docks.

### BACKGROUND

Shipping dock detention periods can negatively impact a commercial driver's hours-of-service (HOS) cycles which can lead to lost efficiency, to increased costs and to safety issues. Long dock detention times affect a driver's schedule, meaning less income for the driver. A Department of Transportation report estimates dock detention times can reduce driver income by $1.1 billion to $1.3 billion for for-hire commercial motor vehicle drivers in the truckload sector. The Government Accountability Office found “about 65 percent of drivers reported lost revenue as a result of detention time from either missing an opportunity to secure another load or paying late fees to the shipper.”

Drivers running late on deadlines may become frustrated and may compensate for lost time with dangerous driving behavior such as driving while fatigued, speeding, and violating HOS requirements. The Office of Inspector General released a trucking-industry report related to prolonged shipping dock wait times confirming the problem. The report estimated that a 15-minute added wait time leads to a 6.2% rise in crash rates. It is not uncommon for drivers to experience much longer dock detention periods.

Prior art methods and devices gather and report on general dock detention trends and statistics, however, most of this reporting data is subjective, comes from hearsay and memories of unhappy drivers, and is not accurate. Other prior art methods rely upon the driver to remember to launch a specialty application upon encountering a dock detention event, rely upon the driver to record the detention period, rely upon the driver to enter or select an individual dock address, company name, latitude/longitude to identify location and provide no automation of any metrics to ensure accuracy of location and duration of the dock detention events. This subjective data is prone to inaccuracies.

### SUMMARY

In one aspect of the invention, a method for calculating a shipping dock detention period for a vehicle and an individual shipping dock is provided. The method includes the steps of providing a daily work flow process to a driver, enabling the driver to initiate the start of a dock detention timer at an individual shipping dock using the daily work flow process, determining the end of the dock detention period without input from the driver, and calculating the dock detention period.

In another aspect of the invention, a method for gathering dock detention data for a specific shipping dock used by multiple drivers with vehicles is provided. The method includes the steps of providing multiple drivers a daily work flow process, enabling each of the drivers to initiate the start of a dock detention timer at the same individual shipping dock using the daily work flow process, determining the end of the dock detention period without input from the drivers, calculating the dock detention period for each of the multiple drivers at the specific shipping dock and accumulating the dock detention periods for each of the multiple drivers at the specific shipping dock into a database.

In another aspect of the invention, a method for predicting shipping dock detention periods for vehicles at shipping docks is provided. The method includes the steps of providing a daily work flow process to vehicle drivers, enabling the drivers to initiate the start of a dock detention timer at an individually identified shipping dock using the daily work flow process, determining the end of the dock detention period for each driver at each individually identified dock without input from the driver, calculating the dock detention period for each individual identified dock, aggregating the dock detention periods for all of the individually identified docks and predicting the delay at an individually identified dock for a given day and time.

Other aspects of the invention will become apparent by consideration of the detailed description and accompanying drawings.

### BRIEF DESCRIPTION OF THE DRAWINGS

FIG. 1 illustrates a schematic view of a vehicle in three different positions at a shipping dock facility;

FIG. 2 is schematic view of an application, vehicle and remote processor/database.

FIG. 3 is a graphical user interface of an hours-of-service application on a HOS device;

FIG. 4 is a flowchart of the operation of the invention;

FIG. 5 is an exemplary report; and

FIG. 6 is an exemplary report.

Before any embodiments of the invention are explained in detail, it is to be understood that the invention is not limited in its application to the details of constructions and the arrangement of components set forth in the following description or illustrated in the drawings. The invention is capable of other embodiments and of being practiced or of being carried out in various ways.

### DETAILED DESCRIPTION

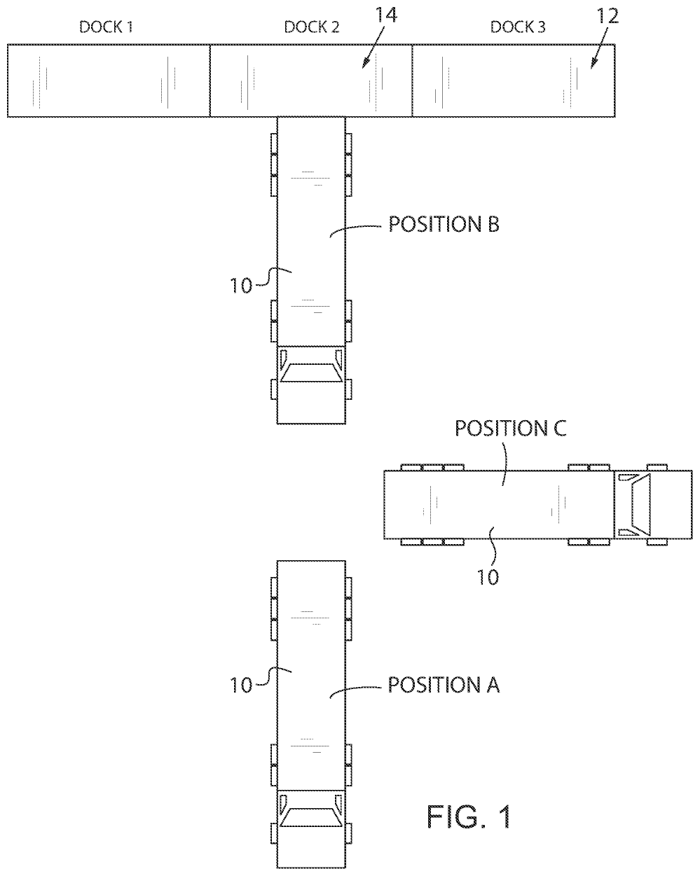

Referring to FIG. 1, there is shown a vehicle 10 (at a position A) that has arrived at a shipping dock facility 12 and is waiting for an individual shipping dock 14 to become available. The time period the driver waits to access the specific dock 14 is termed the staging period. When the waited-for dock 14 is free and the vehicle 10 is allowed access, the driver moves the vehicle 10 into the dock 14 (at a position B). The time period the driver waits in the dock 14 before the unloading begins is termed the waiting period such as waiting for unloading personnel to arrive. The unloading of the vehicle 10 then begins and ends. The time period during which the vehicle 10 is being unloaded until the vehicle 10 moves away from the dock 14 (at a Position C) is termed the unloading period. The detention period is preferably made up the staging period, the waiting period and the unloading period, however, it was also be a subset of those periods.

The present invention calculates accurate dock detention periods using driver input from a daily work flow process to start a timer with no driver input needed to stop the timer and with no geofencing being utilized. The combination of driver ease and incentive to start the dock detention timer as part of the driver's daily workflow process and the automated detection of the termination of the dock detention period without driver intervention provides for accurate dock detention data and a larger volume of objective data that can be used in the industry. Drivers are incented to use the invention regularly to gather data in that dock detention periods ultimately negatively impact their compensation, it gives them a record of events they frequently complain about, it gives dispatchers/managers more accurate data on driver activity/inactivity, dispatchers/managers will contact the driver less often to ask for status, and drivers will have more efficient routes based upon delivery locations and potential dock detention delays.

With the driver starting a dock detention timer, the invention makes the initiation of the dock detention period objective because it happens in real time and because it is part of the driver's daily workflow process. The invention provides a more accurate representation of actual dock delay periods by automatically stopping the timer without driver intervention so the driver does not have to remember to do so which can lead to inaccurate data.

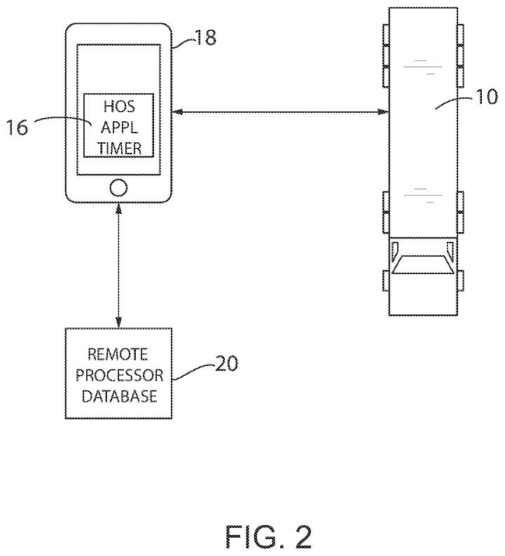

More specifically, the daily work flow process is preferably a HOS application, however, other such daily work flow processes such as dispatch and routing can be utilized. The daily work flow process is a process that a driver uses to manage their day and that they are familiar with. It is not a separate program, application or step that a driver has to access to initiate the dock delay timer. As shown in FIG. 2, the HOS application 16 is on a smart device 18 that communicates with the vehicle 10 and communicates with a remote processor/database 20.

Operators of commercial motor vehicles (CMVs) are required to comply with regulations for operating such vehicles. For example, drivers of CMVs are required to comply with hours-of-service (HOS) regulations. The U.S. Department of Transportation, Federal Motor Carrier Safety Administration (FMCSA) has established a comprehensive list of regulations that professional drivers of CMVs must comply with. Drivers must comply with the obligations imposed under federal and state requirements, and these requirements include not only physical and age requirements but also define the ways a driver can lose commercial driving privileges.

Many CMVs equip their drivers with HOS software that assists drivers in complying with the HOS regulations. Commonly, the HOS software is in the form of an application, such as for example the KELLERMOBILE® app and other known apps in the industry and is commonly accessible on a device such as a smart phone, laptop, portable tablet, and the like, hereafter referred to as a HOS device. The HOS software is part of a driver's normal daily work flow process. Dock detention delays at shipping docks can affect a driver's HOS compliance. The present invention makes use of a HOS application 16 that is a part of a driver's normal work flow to accurately collect, calculate and use docket detention data.

Commercially available daily workflow process, such as a HOS application 16, can be adapted to be used with this invention with the addition of a timer and an interface for the driver to initiate the timer.

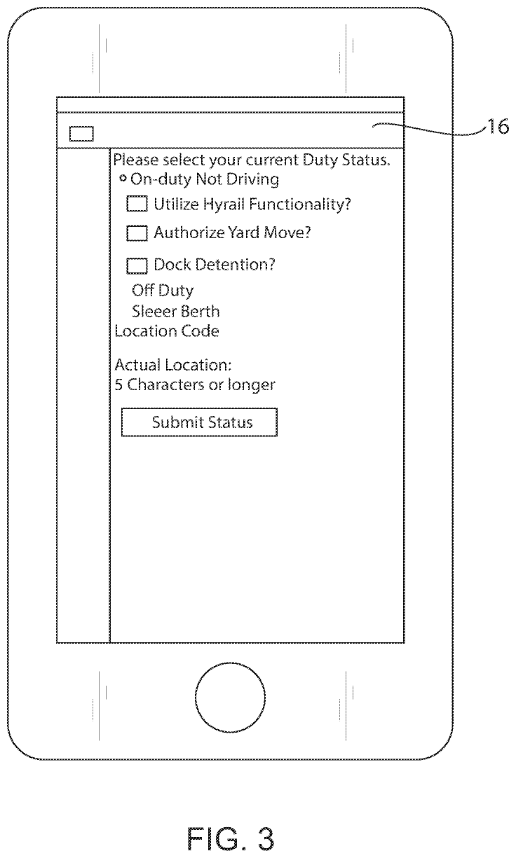

In the present invention, the driver has access to the HOS application 16 such as via an interface, an example of an interface on the HOS device 18 is shown in FIG. 3.

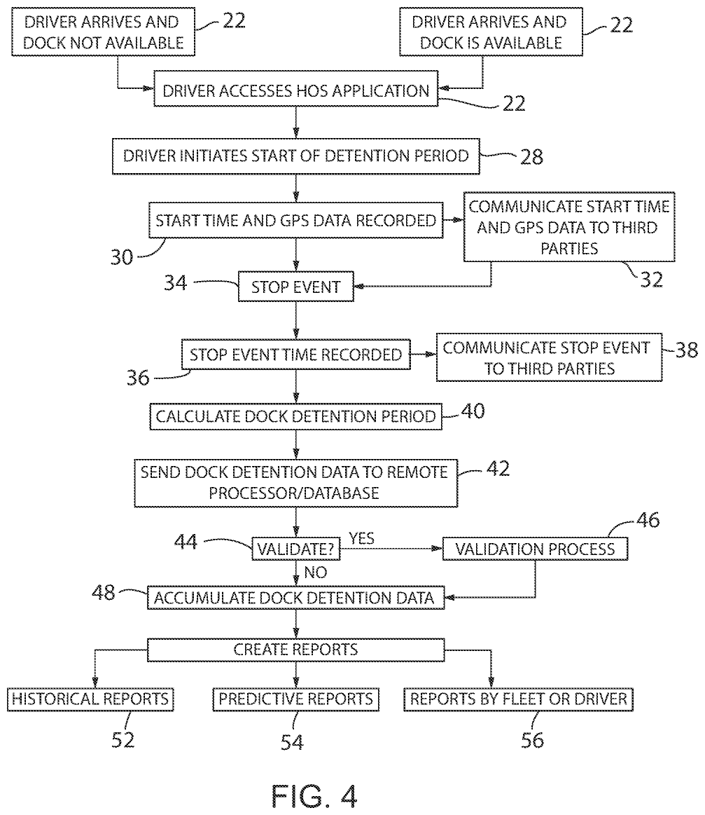

Turning now to FIG. 4, upon arrival at an individual dock 14 that is not yet available at step 22 or is available at step 24, the driver of the vehicle 10 accesses their HOS application 16 at step 26 and initiates the start of the dock detention period at step 28 such as by pressing a radio “START” button or other such start mechanism on the HOS device 18 or by manually entering a start time. After the dock detention start time is initiated by the driver, the HOS application 16 will record the start time and the GPS location at step 30 to identify the specific individual dock 14. The driver can have the option to enter an address, dock owner, dock identifier or other relevant location related information, or this data can be automatically obtained by the HOS device 18 such as by using GPS data. The HOS device 16 can store the data relating to the docket detention events. The docket detention data includes, for example, the start and end times of the dock detention period, the calculated dock detention period, the identification of and location of the individual dock 14, the day/time and other relevant data. The HOS application 16 can also be configured at step 32 to (a) communicate with fleet dispatchers/managers to make them aware of the start of a dock detention period in real time so that they do not need to check in with the drivers for status, (b) communicate with the dock/facility and docket detention mechanisms and sensors, and (c) communicate with the vehicle's electronic logging device (ELD).

The dock detention timer will stop at the end of the dock detention period without input or intervention from the driver upon the occurrence of a stop event at step 34. The stop event can include (a) the driver's resumption of the vehicle route by detecting a vehicle 10 speed above a certain mph, for example 5 mph, as detected by an ELD or like device in communication with the HOS device 18; (b) the vehicle 10 being a distance from the dock 14 as determined by GPS data; or (c) other such mechanisms that definitively indicate the driver is no longer held up in a dock detention event at the individual dock 14 and that do not require driver intervention.

Upon the stop event and the end of the docket detention period, the dock detention data for that individual dock 14 is recorded at step 36, the dock detention period is calculated at step 40 and sent by the driver's HOS device 18 to a remote processor/database 20 to accumulate dock detention data from a single or multiple drivers and single or multiple docks for later processing and reporting. Alternately, the remote processor/database 20 can be utilized to calculate the dock detention period from the data collected by the HOS application 16.

Dock detention data can be validated at steps 44 and 46, if required, either by the driver approving the calculated dock detention period and associated data or in an automated fashion by comparison of the dock detention data to the driver's assigned route.

The dock detention data can be sent at step 38 in real time to third parties responsible for a vehicle's route such as a driver's carrier back office or dispatchers/managers, for example. Such third parties can be notified upon the start of the dock detention period and again at the resumption of the driver's route. The real time dock detention data of a driver at a specific carrier can be used in real time by that carrier to schedule deliveries of other drivers at the same dock or to adapt that driver's route schedule.

In addition to use in real-time, the dock detention data from the various docks and drivers can be accumulated at step 48 into a database for reporting out the historical data and for predicting dock detention periods at specific docks such as by day of the week and time. Historical and predictive reports at steps 52, 54 and 56 for individual docks, such as by day of the week or hour of the day, better inform drivers and fleet dispatchers/managers in planning routes and in planning dock pickup/delivery times to avoid long wait times as shipping docks. With such reports, drivers may use their time more efficiently, increase their compensation and potentially decrease their frustration and crash occurrences. With such reports, carriers can negotiate better shipping rates, improve route times and improve loading/unloading efficiencies. With such reports, shipping dock operators can work to decrease dock detention periods and increase dock efficiency. Such historical reports can be driver specific, fleet specific or shipping dock facility specific and be generated on a given time interval such as weekly or monthly for example.

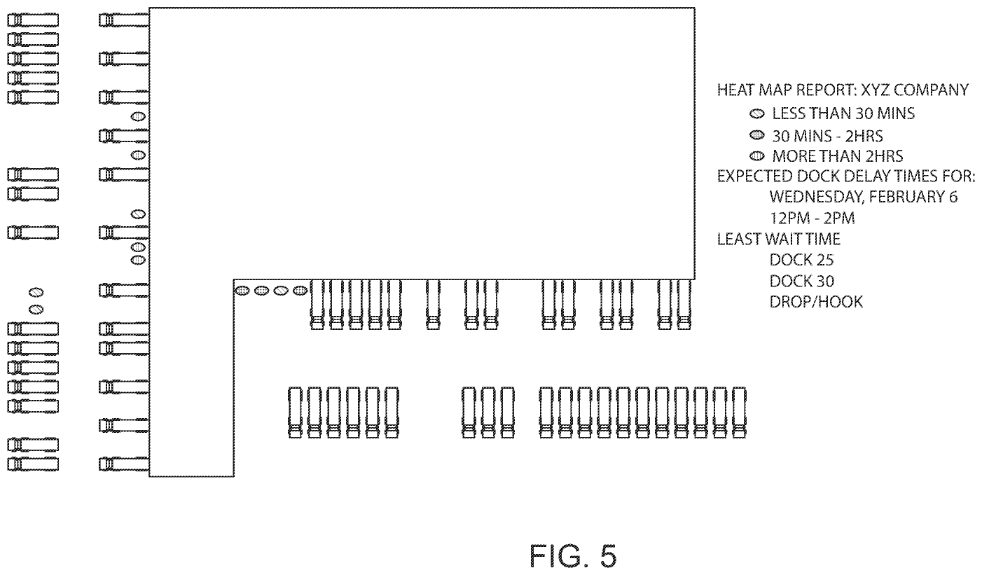

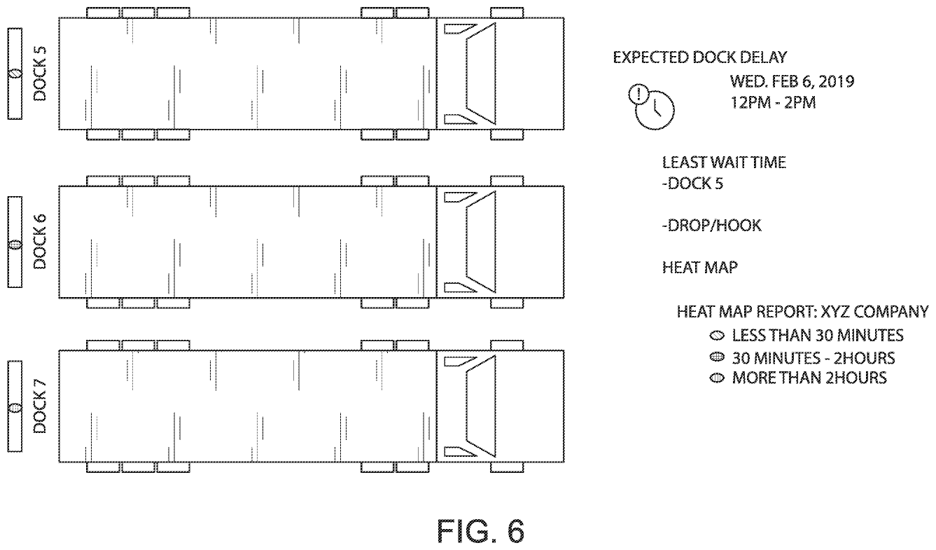

Exemplary reports that can be generated are shown in FIGS. 5 and 6. The data accumulated for such historical and predicative reports can change at any interval such as daily, hourly or in real-time.

Various features and advantages of the invention are set forth in the following claims.

1. A method for calculating a shipping dock detention period for a vehicle and an individual shipping dock, said method comprising:
providing a daily work flow process to a driver;
enabling the driver to initiate the start of a dock detention timer at an individual shipping dock using the daily work flow process;
determining the end of the dock detention period without input from the driver; and
calculating the dock detention period.

2. The method of claim 1 and further including the step of sending the dock detention period to at least one of a remote database for accumulating with other data and a third party responsible for the vehicle's route.

3. The method of claim 1 wherein the driver daily work flow process includes an hours-of-service application.

4. The method of claim 3 wherein, in the enabling step, the initiation of the start of the dock detention timer is enabled by a start interface.

5. The method of claim 1 wherein the end of the dock detention period is determined by GPS data.

6. The method of claim 1 wherein the end of the dock detention period is a determined by measuring the speed of a vehicle.

7. The method of claim 1 wherein, in the calculating step, the dock detention period is made up of staging, waiting and unloading periods.

8. The method of claim 1 wherein the dock detention period includes at least one of the staging, waiting and unloading periods.

9. A method for gathering dock detention data for a specific shipping dock used by multiple drivers with multiple vehicles, said method comprising:
providing multiple drivers a daily work flow process;
enabling each of the drivers to initiate the start of a dock detention timer at the same individual shipping dock using the daily work flow process;
determining the end of the dock detention period without input from the drivers;
calculating the dock detention period for each of the multiple drivers at the specific shipping dock; and
accumulating the dock detention periods for each of the multiple drivers at the specific shipping dock into a database.

10. The method of claim 9 and further including the step of preparing a report with the accumulated dock detention period data.

11. The method of claim 9 wherein the daily work flow process includes an hours-of-service application.

12. The method of claim 9 wherein, in the enabling step, the initiation of the start of the dock detention timer is enabled by a start interface on a mobile phone.

13. The method of claim 9 wherein the end of the dock detention period is determined by at least one of GPS data and measuring the speed of a vehicle.

14. The method of claim 9 wherein the dock detention period includes at least one of staging, waiting and unloading periods.

15. A method for predicting shipping dock detention periods for vehicles at shipping docks, said method comprising:
providing a daily work flow process to vehicle drivers;
enabling the drivers to initiate the start of a dock detention timer at an individually identified shipping dock using the daily work flow process;
determining the end of the dock detention period for each driver at each individually identified dock without input from the driver;
calculating the dock detention period for each individual identified dock;
aggregating the dock detention periods for all of the individually identified docks; and
predicting the delay at an individually identified dock for a given day and time.

16. The method of claim 15 wherein the daily work flow process includes an hours-of-service application on a mobile phone.

17. The method of claim 15 wherein in the enabling step, the initiation of the start of the dock detention timer is enabled by a start interface.

18. The method of claim 15 wherein the end of the dock detention period is determined by GPS data.

19. The method of claim 15 wherein the end of the dock detention period is a determined by measuring the speed of a vehicle.

20. The method of claim 15 wherein, in the calculating step, the dock detention periods include at least one of the staging, waiting and unloading periods.
